(19) United States
(12) Patent Application Publication
(10) Pub. No.: US 2026/0228080 A1
(43) Pub. Date: Aug. 6, 2026

(54) TROUBLESHOOTING ACTION PLAN GENERATION USING INTEGRATED PROGRAMMATIC AND SPECIALIZED GUIDED AND CONSTRAINED ARTIFICIAL INTELLIGENCE

(71) Applicant: Trilogy Enterprises, Inc., Austin, TX (US)

(72) Inventors: Arthur Michel, Brooklyn, NY (US); Colin Guilfoyle, Drogheda (IE); Pablo Ambram, Buenos Aires (AR); Balaji Jayaraman, Chennai (IN)

(73) Assignee: Trilogy Enterprises, Inc., Austin, TX (US)

(21) Appl. No.: 19/378,020

(22) Filed: Nov. 3, 2025

Related U.S. Application Data
(60) Provisional application No. 63/714,901, filed on Nov. 1, 2024.

(51) Int. Cl. G06F 11/07

(52) U.S. Cl. CPC G06F 11/079; G06F 11/0715

(57) ABSTRACT

An exemplary troubleshooting action plan generation system and method processes customer tickets, accesses data from a troubleshooting action plan (TAP) database, and maps one or more issues from the customer ticket TAP database. The exemplary troubleshooting action plan generation system and method accesses relevant data from the user data and TAP database and modifies a tailored prompt, created by a prompt engineer. An technical support bot, equipped with an action plan generator and supported by a query augmentation artificial intelligence model, ticket summarizer AI model, and attachment analysis LLM, produces a comprehensive troubleshooting action plan.

### CROSS-REFERENCE TO RELATED APPLICATION(S)

This application claims the benefit under 35 U.S.C. § 119(e) and 37 C.F.R. § 1.78 of U.S. Provisional Application No. 63/714,901, which is incorporated by reference in its entirety.

### FIELD OF THE INVENTION

The present invention relates in general to the field of electronics and more specifically to a troubleshooting action plan generation system and method that receives a customer ticket from the customer support platform and generates a troubleshooting action plan using integrated programmatic and specialized guided and constrained artificial intelligence.

### DESCRIPTION OF THE RELATED ART

Manual troubleshooting involves human technicians identifying and resolving issues in a product or service. The human technicians use knowledge, experience, and intuition to diagnose problems. The human technicians follow a step-by-step process to isolate the root cause of an issue. The human technicians often consult documentation, perform tests, and analyze symptoms. The human technicians may use basic tools or equipment to gather more information about the problem. Manual troubleshooting relies heavily on individual expertise and can vary in effectiveness and efficiency.

Static troubleshooting guides provide fixed, predetermined steps for resolving common issues. The static troubleshooting guides are created based on known problems and their solutions. Technicians follow the static troubleshooting guides sequentially, performing each step as instructed. The static troubleshooting guides often use flowcharts or decision trees to lead users through the troubleshooting process. The static troubleshooting guides typically cover a limited range of scenarios and don't adapt to unique or evolving problems. The static troubleshooting guides offer consistency but lack flexibility for handling complex or unforeseen issues.

Knowledge base troubleshooting systems store and organize solutions to known problems in a searchable database. Technicians query the knowledge base troubleshooting system using keywords, error codes, or symptoms to find relevant articles. The knowledge base troubleshooting system retrieves and presents matching entries, which often include step-by-step instructions or explanations. The customers can rate the effectiveness of solutions, helping to improve the quality of the knowledge base troubleshooting systems over time. The knowledge base troubleshooting systems allow organizations to capture and share institutional knowledge but may struggle with novel or complex issues.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary troubleshooting action plan generation system.

FIG. 2 depicts an exemplary troubleshooting action plan generation method, utilized by the troubleshooting action plan generation system.

FIG. 3 depicts a block diagram for the exemplary troubleshooting action plan generation method, which is an embodiment of the exemplary troubleshooting action plan generation method of FIG. 2.

FIG. 4 depicts a sequence diagram for the exemplary troubleshooting action plan generation system, which is an embodiment of the exemplary troubleshooting action plan generation system of FIG. 1.

FIG. 5 depicts a flow diagram for a method of selection between component-specific strategies and general strategies, which is an embodiment of the exemplary troubleshooting action plan generation method of FIG. 2.

FIG. 6 depicts a flow diagram from issue identification to the generation of troubleshooting action, which is an embodiment of the exemplary troubleshooting action plan generation method of FIG. 2.

FIG. 7 depicts a system log entry.

FIG. 8 depicts a list of products or services in a user interface of the TAP database.

FIG. 9 depicts a flow chart of a process and interactions between different components in the exemplary troubleshooting action plan generation method 900, which is an embodiment of the exemplary troubleshooting action plan generation method of FIG. 2.

FIG. 10 depicts a detailed flow chart of a process and interactions between different components in the Atlas system 1000, which is an embodiment of the exemplary troubleshooting action plan generation method of FIG. 2.

FIG. 11 depicts troubleshooting strategies and artifacts needed for product or service in the TAP database.

FIG. 12 depicts a user interface that allows customers to configure a project in a software system.

FIG. 13 depicts a flow from categorizing the issues to the generation of a troubleshooting action plan, which is an embodiment of the exemplary troubleshooting action plan generation method of FIG. 2.

FIG. 14 depicts an exemplary network environment in which the system of FIG. 1 and the process of FIG. 2 may be practiced.

FIG. 15 depicts an exemplary computer system.

### DETAILED DESCRIPTION

An exemplary troubleshooting action plan generation system and method receives customer tickets through a ticket management platform, capturing issues related to components of products or services along with user data such as logs, input files, and past tickets. The exemplary troubleshooting action plan generation system and method maps the identified issues to one or more components in a troubleshooting action plan (TAP) database. After mapping, the mapping module accesses relevant data from this database, including component details, issue descriptions, general troubleshooting strategies, and related artifacts needed.

A prompt generator creates a tailored prompt for generating the troubleshooting action plan, incorporating necessary data from both the user database and the TAP database. The exemplary troubleshooting action plan generation system and method provide this generated prompt, along with other fetched data, to a technical support bot. The level of technical support is a matter of design choice. In at least one embodiment, the technical support is Level 2 (L2) or Level 3 (L3) level support. In at least one embodiment, L2 support is advanced technical support that provides technical support on issues that initial human or machine frontline Level 1 support cannot. L3 support is advanced technical support, such as engineer and developer level support, that provides technical support on issues that L2 support cannot. The technical support bot, equipped with an action plan generator and supported by a query augmentation artificial intelligence model, ticket summarizer AI model, and attachment analysis AI model, produces a comprehensive troubleshooting action plan. In at least one embodiment, the particular model is one or more large language models that are trained to perform query augmentation, ticket summarization, and attachment analysis. In at least one embodiment, the models are individual specialized models. In at least one embodiment, at least two of the query augmentation, ticket summarization, and attachment analysis functions are performed by a single model.

The exemplary troubleshooting action plan generation system and method provide customers with efficient solutions to their problems. The exemplary troubleshooting action plan generation system and method creates step-by-step instructions that guide customers through the resolution process in a timely manner. By following these carefully crafted plans, customers can minimize downtime and quickly restore their product or service to optimal functioning.

The exemplary troubleshooting action plan generation system and method incorporates a comprehensive monitoring framework to ensure the TAP database remains effective and up-to-date.

The exemplary troubleshooting action plan generation system and method use a customer support and help desk platform, such as a cloud based software system (e.g. Zendesk) retrieval augmented generation (RAG) and a TAP database RAG. In at least one embodiment, the Zendesk RAG is used to enhance the system's ability to retrieve relevant information from a customer service platform such as Zendesk. The Zendesk platform, which typically stores customer support tickets and documentation, helps improve the quality and relevance of generated responses by incorporating specific data related to customer interactions. In parallel, the TAP database RAG accesses and integrates data from a more generalized repository of information. By using this RAG, the exemplary troubleshooting action plan generation system and method can better understand the context of a query and generate more accurate and informed responses.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its(their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

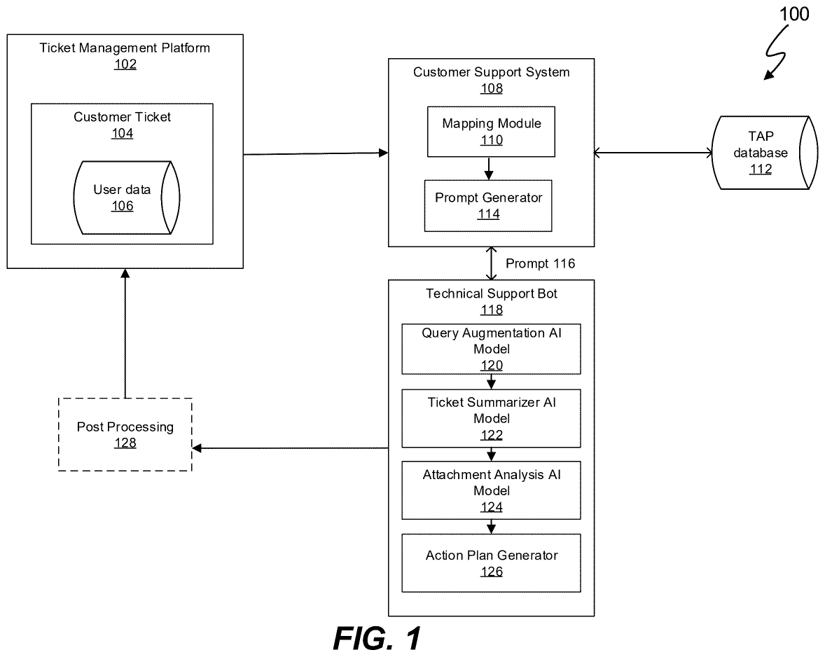

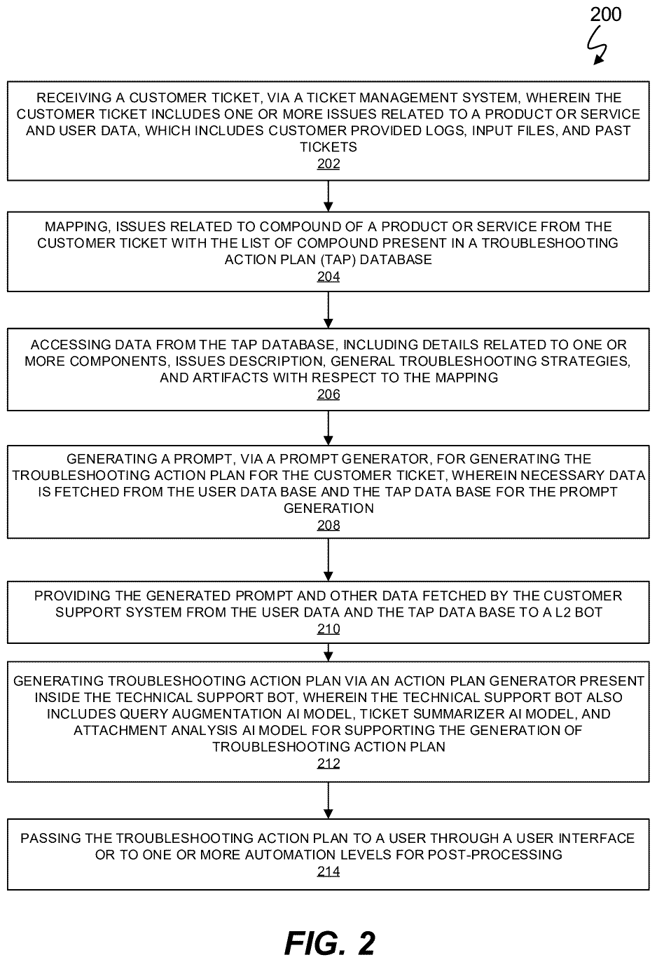

FIG. 1 depicts an exemplary troubleshooting action plan generation system 100, and FIG. 2 depicts an exemplary troubleshooting action plan generation method 200, utilized by the exemplary troubleshooting action plan generation system 100 of FIG. 1.

Referring to FIGS. 1 and 2, in operation 202, a ticket management platform 102 transfers a customer ticket 104 to a customer support system 108, wherein the customer ticket 104 includes one or more issues related to a product or service. For example, in one of the customer tickets the issues reported by the customer related to Kerio connect application includes: “Umlaute breaks when saving emails as drafts. However, there is no issue when writing and sending emails instantly. Whenever a customer saves an email in his drafts folder, the Umlaute breaks after switching to another folder and then back to drafts. The customer is using Outlook with KOFF as his email client, but the issue doesn't occur when writing and saving emails in drafts via Webmail. Using Webmail or Outlook's Rich Text isn't an option, as it contradicts the customer's workflow.” In another customer ticket, the customer issues are related to another product NewNet “LGP disk space reaches high values quickly, even though no additional data is added, so need to identify the root cause and find a solution. All LGPs on the RMD-cloud (LGP1, LGP2, LGP3, and LGP4) are affected.”, where LGP is specific processes within a system that generate logs to track events, errors, and system activities.

The customer ticket 104 also includes a user data 106, which has customer-provided logs, input files, and past tickets. The customer-provided log is a system-generated file that records events, errors, or activities within an application or system. The customer-provided log helps support teams identify and diagnose issues based on real-time data from the customer's environment. The customer-provided log contains timestamps, error codes, and other technical details. For example:

| | |
|---|---|
| [30/12/2019 16:02:40.461] ************************** | Creating |

log file **************************

Number of

cores: 16

CPU0:

Intel(R) Xeon(R) CPU E5-2640 v4 @ 2.40GHz

Process

Affinity Mask: >1111111111111111<

Windows

version: Windows NT 6.2 (Window Server 2012)

Windows

locale: English_United Kingdom.1252

Time

zone: GMT Standard Time

Firebird

version: 9.2.10.4692

File

system: NTFS (fixed disk)

Free

space: 1009080468 k

Version:

KMS.KOFF64 9.2.10.4692

| | |
|---|---|
| [30/12/2019 16:02:40.461] ****** START ****** | Common log has |

just started (KMS.KOFF64 9.2.10.4692)

| | |
|---|---|
| [30/12/2019 16:02:40.461](4332){dbg}{mapi-provider} | In |

Service\ConfiguratorBase.cpp:1261
(ConfiguratorBase::verifyCommonSectionPresence)

| | |
|---|---|
| [#1] (common) | Common |

profile section not found - creating new one

| | |
|---|---|
| [30/12/2019 16:02:40.461](4332){dbg}{mapi-provider} | In |

Service\ConfiguratorBase.cpp:1293
(ConfiguratorBase::verifyCommonSectionPresence)

| | |
|---|---|
| [#2] (common) | Common |

profile section created

| | |
|---|---|
| [30/12/2019 16:05:45.054](4484){err}{communication} | In |

SCProvider\Communicator.cpp:291 (Communicator::checkAndLogResult)

| | |
|---|---|
| [#3] (common) | Exception of |

class HResultException:SCProvider\HttpConnection.cpp(131),
HttpConnection::checkStatus:

0x80042011

KOFF_E_UNAUTHORIZED (Request info: Server Ping) (Response info: status
= 401 Unauthorized)

| | |
|---|---|
| [30/12/2019 16:05:45.054](4484){err}{synchronizer} | In |

SCProvider\Synchronizator.cpp:1990 (Synchronizator::testSyncCondition)

| | |
|---|---|
| [#4] (common) | Bad |

authorization - you need to start synchronizator with correct server
configuration!

HRESULT:

0x80042011 KOFF_E_UNAUTHORIZED

| | |
|---|---|
| [30/12/2019 16:05:45.054](4332){err}{mapi-interface} | In |

Service\ConfiguratorCREATE.cpp:122 (ConfiguratorCREATE::testAccount)

| | |
|---|---|
| [#5] (common) | Exception of |

class HResultException: Service\ConfiguratorBase.cpp(217),
ConfiguratorBase::getServerInfo:

0x80042011

KOFF_E_UNAUTHORIZED

| | |
|---|---|
| [30/12/2019 16:06:14.851] ******* END ******* | Common log has |

just finished

| | |
|---|---|
| [30/12/2019 16:06:14.851] ***** CLOSING ***** | Closing Log |

The input files are the files uploaded by the customer through the ticket management platform 102. The input files can include one or more screen shots of the error message, details of the error, and one or more screen recordings related to the error message and details of the error. The past tickets are customer ticket 104 that the customer previously submitted through the ticket management platform 102.

In operation 204, accessing data from a troubleshooting action plan (TAP) database 112, including details related to one or more components, issue descriptions, troubleshooting strategies, and artifacts needed. The component in a product or service encapsulates a specific functionality or feature. The component interacts with other components through well-defined platform. Example for components in a product “dnn” is: Active Directory Authentication Configuration, Admin UI/UX|Persona Bar, AUM|IIS Rewrites, Database Configuration, Deprecated Features, Developer Support—Documentation, Emails|Notifications|SMTP, Email Verification, End-User UI/UX|CSS, Engage Modules|Gamification, HTML Editor|Scripts, IIS Configuration, License Activation Issues, License Generation, Licensing Information, Emergency Licenses, Localization, Microservices, New Installation or Migration, Portal Alias Bindings|SSL, Product Usage, Sales Enquiries, Search Indexing|Lucene, Security Alerts, SEO Analytics, Site Groups, Site Import/Export, Themes|Skins|Containers|Skin Objects, Third-Party Component Integration—Documentation, User Accounts|Roles|Registration, Web Farm Configuration—Setup, Website Upgrade, Workflow, Active Directory Authentication—Troubleshooting, Client-Side Performance, Server-Side Performance, Third-Party Component Integration—Core DNN integration and Web Farm Configuration—Troubleshooting.

The issues description provides a clear explanation of a specific problem or functionality in a product or service, along with expected troubleshooting or configuration tasks. For example, the issue description of a product “dnn” associated with the component Active Directory Authentication—Configuration is “DNN introduced the Persona Bar for content managers and community managers in Evoq 8.5. In Evoq 9.0 and DNN Platform 9.0, DNN extended the Persona Bar to replace the Control Panel/Bar for hosts and administrators. The Persona Bar varies according to the product and to the permissions granted to the current authenticated (logged-in) user through roles. L1s should be able to direct users to configure the Persona Bar. Examples: General Persona bar configuration, Control bar to Persona bar, Client side problems in Persona bar, Administrator best practices, How to perform general administrative tasks”. The issue description of a product skyvera_monitization associated with the component missing orders is “Orders missing on CRM but the API call informs that it exists”.

The troubleshooting strategies are the general strategies used for the troubleshooting of a component of the product or service. The troubleshooting strategies also contribute to the generation of a troubleshooting action plan. For example, the troubleshooting strategies of a product “dnn” associated with the component License Generation is,
“If the request is for new/additional licenses, support should verify the validity of the request by opening a side conversation with the customer's AM.
If the request is about a full renewal/extension of their existing licenses, then Support should request the customer to provide a customer-signed quote or a generated invoice, and if the same is shared by the customer, then Support agents can proceed directly with the full license renewal/extension based on the dates in the quote/invoice.
If the quote shared by the customer is not signed by them, but they have a subsequent generated invoice available, then the invoice document is sufficient to continue to go ahead.
If a customer-signed quote is not available, then the existing process would continue to internally reach out to the customer's AM and seek internal inputs and approvals.”

The troubleshooting strategies of a product “aurea archiver” associated with the component Import emails Issues is,
“1) Verify the source and format of the emails being imported (PST, Exchange, and EML files) to ensure compatibility with GFI Archiver's Import Export Tool (IET).
2) Confirm how the emails are imported from the following options: Importing a PST into Archiver using the Import Export Tool (IET), Importing EML files into GFI Archiver using simple command prompts, Importing Emails from Exchange using the Import Export Tool (IET), or through the client-side Archive Assistant (an add-in for Microsoft Outlook).
2) Confirm that the GFI Archiver Import Export Tool (IET) is correctly configured for the intended import task (in case it is used), including proper assignment of imported emails to an additional owner if applicable.
3) Check the logs for any error messages or warnings that occurred during the import process, particularly focusing on authentication, permissions, or file format issues.
4) Ensure that the email accounts being imported have the necessary permissions set for the Archiver to access and import their emails.
5) For server-side imports, verify the connection to the Exchange server or any other email server source is stable and correctly configured.
6) If using the client-side Archive Assistant for Outlook, ensure it's properly installed and configured to access the correct data sources (PST files, Exchange, IMAP, or POP3 mailboxes).”

The artifacts needed refer to the essential documents, tools, data, or deliverables required to generate the troubleshooting action plan.

The exemplary troubleshooting action plan generation system 100 directs Zendesk to retrieve additional context. Zendesk actively searches for relevant information related to the same or similar customer ticket 104. The exemplary troubleshooting action plan generation system enables Zendesk to gather more details to enhance customer ticket 104.

In operation 206, a mapping module 110 maps issues related to one or more components of a product or service from the customer ticket 104 with the list of components present in a TAP database 112. A product or service has been divided into different components; for example, a product named ‘kandy’ is divided into different components such as new agent onboarding, SIP troubleshooting, backend troubleshooting, Edgemarc, MCP, and vulnerabilities. another example is a product named ‘aurea acrm’ which includes components such as CRM Web (Web), CRM.Pad (Pad/iPad), CRM Win, CRM Designer, CRM ConnectLive, CRM Launcher, CRM Connector, CRM Interface, CRM Weboffline, CRM.Client, CRM Mobile, CRM WebServices, CRM Cockpit, CRM Phone, CRM IIS, CRM Citrix.

When the customer raises the customer ticket 104 related to the product or service, the mapping module identifies one or more components of the product or service that has issues. The mapping module 110 maps the one or more components that has issues with the one or more component present in the TAP database 112. After the mapping of one or more components with the TAP database 112, the mapping module 110 extracts the data from the TAP database 112 including issue description, troubleshooting strategy, and artifacts needed.

For example, in one scenario the user provides following inputs related to a product named ‘NewNet’:
“i had an issue in common config files
* synching does not take place on other routers when we have applied on one rtr
* in normal case scenarios, when we change common config file on one cloud router, common config files on all other cloud routers should be changed but the case now that changing common config file on one cloud router does not reflect on all other routers.”

For the above given inputs in the customer ticket 104, the component of ‘NewNet’ identified to have this issues is “Inquiries about configuration changes or issues.” The mapping module 110 extracts following data from the TAP database 112 based on the relevance of data to the provided issues “Inquiries about configuration changes or issues”. The data extracted from the TAP database 112 further includes issue description, troubleshooting strategy, and artifacts needed. For this example, the extracted issue description is:
“Inquiries related to how to perform a certain change or modify certain parameter. Specific configuration issues in the tp_walkall, host_config.txt file or common_config file. Trying to change or correct default configuration”

The extracted troubleshooting strategy is:
“1) Make sure to understand which configuration they are enquiring about; what is the default, and what are they hoping to achieve?
2) Has the customer confirmed the configuration as defined in the operator manuals.
4) Is the parameter already defined on the UI or in any of the configuration files?
3) If the customer is complaining about changes not being persistent, confirm that they have made the changes on the common_config.txt of the RTR server, which would always get ovverriden by the common_config of the MGR server.”

The extracted artifacts needed are:

“- /var/log/messages
- tp_walkall command output
- common_config.txt file from the /usr/TextPass/etc directory.
- hostname_config.txt file from the /usr/TextPass/etc directory.”

The mapping module 110 categorizes issues by grouping them according to different products or services and their specific components. The mapping module 110 analyzes the nature of each issue and determines whether human intervention is necessary. When the mapping module 110 identifies that human involvement is required, the mapping module 110 ensures the appropriate action is taken, directing issues to the relevant personnel for resolution.

The exemplary troubleshooting action plan generation system includes component-specific troubleshooting, which identifies the component associated with the issues. Once the problematic component is recognized, the exemplary troubleshooting action plan generation system 100 develops a tailored troubleshooting action plan specific to the component.

In operation 208, a prompt generator 114 generates a prompt 116 for generating the troubleshooting action plan for the customer ticket 104, wherein necessary data is extracted from the user data 106 and the TAP database 112 for the prompt generation. The prompt 116 includes a system prompt and an input prompt. The system prompt refers to special instructions or set of guidelines given to the technical support bot 118 that sets the tone, behavior, or role the technical support bot 118 should follow throughout an interaction. The input prompt is the prompt provided to the technical support bot 118 for generating specific output.

Prompt engineer generates a basic schema or structure of the prompt 116, and the prompt generator 114 updates or populates the prompt 116 to finalize the prompt. The prompt engineer designs the initial schema, outlining the essential instructions. The prompt generator 114 updates the schema with the data received in user data 106 and TAP database 112.

An example of the prompt 116 used by the technical support bot 118 for the generation of the troubleshooting action plan is provided below:

```
  [
    {
      “role”: “system”,
      “content”: “You are a helpful technical assistant, who is
a very experienced customer support agent. In your answers, I expect to
never see any private information such as application credentials,
emails, phone numbers, addresses or passwords. However, customer first
names are okay to use. Don\”t make stuff up if you don\”t know the
answer. If you analyze information in languages other than English,
detect the language, translate it to English and then analyze it. Your
output should always be in English. Your output should generally be in
Markdown format unless specified otherwise, and you should always try
to be as thorough as possible, but also keep it simple. Do not preface
your response with what you are about to do or acknowledging the type
of task you are performing. Just provide the answer. Also don\”t
postfix your response with any additional information of how you
performed the task or unnecessary details not asked for. Just provide
the answer based on the specified instructions, matter of factly. Take
into consideration the following general instructions too: An Action
Plan consists of a structured set of steps that a support agent must
take to resolve an issue, for a specific component of a specific
product. These steps can include investigating the issue further,
consulting with a team or a higher authority, or performing specific
actions. An Action Plan should include the following general elements:
- A title: ‘Action Plan to Solve issues related to <component>Inquiries
about stuck order</component>’ - Immediate Steps: What are the first
actions we should take upon receiving an issue regarding this
component? - Investigation Process: Outline how we should investigate
the problem. Mention any specific tools, departments, or personnel that
should be involved. - Artifacts: What artifacts should we collect? What
information should we request from the customer? - Solution
Development: Describe how we would develop a solution. Include
potential alternatives in case the primary solution is not feasible. -
Implementation: How will the solution be implemented? Who will be
responsible for each part of the implementation? - Follow-up: What
follow-up actions will be necessary after implementing the solution? To
build these elements you will use the following information that will
be provided: - The component of the product that is causing the issue -
The troubleshooting strategy for this component and product - The
artifacts needed to troubleshoot this component and product
Troubleshooting Strategies: Definition: Troubleshooting strategies are
methodologies or approaches used to diagnose the cause of a problem.
They involve a series of steps or considerations that guide you through
understanding and identifying the issue. Purpose: The main aim is to
identify the problem\”s root cause and understand the circumstances
surrounding the issue. Content: It includes observation techniques,
questioning tactics, diagnostic tests, and methods for replicating the
issue. It often involves understanding the system\”s normal behavior to
recognize anomalies. Example Elements: - Observing symptoms and
patterns. - Checking for recent changes or updates. - Verifying
configurations and settings. - Isolating variables to pinpoint the
cause. Action Plans: Definition: An action plan is a sequence of steps
that must be taken, or activities that must be performed well, for a
strategy to succeed. It\”s a detailed plan outlining the actions needed
to achieve one or more goals or solve a problem once the
troubleshooting has identified the cause. Purpose: The main aim is to
resolve the issue and often to prevent its recurrence. It\”s about
implementing solutions, mitigating the problem, or making changes based
on the findings of the troubleshooting phase. Content: It includes
specific tasks, timelines, responsibilities, resources needed, and
sometimes, contingency plans. It\”s highly actionable and directed
towards achieving an end result. Example Elements: - Detailed steps to
fix the identified issue. - Who will carry out each step and when. -
Resources required for implementation. - Follow-up actions to ensure
the problem is resolved. Artifacts: Definition: Artifacts are data or
physical items collected during the troubleshooting process. These can
include logs, error messages, screenshots, configuration files, or any
other relevant data that provides insight into the issue. Purpose: The
purpose of collecting artifacts is to have tangible evidence or data to
analyze. They help in understanding the problem more deeply, verifying
the accuracy of reported symptoms, and providing a basis for testing
hypotheses during troubleshooting. Use in Troubleshooting and Action
Plans: - In Troubleshooting Strategies, artifacts are used to
understand the problem\”s context, replicate issues, and diagnose the
root cause. They are essential for accurate observation and analysis. -
In Action Plans, artifacts are often used to verify that solutions have
been implemented correctly, to document the state of the system before
and after changes, and sometimes to communicate with stakeholders about
what was fixed or changed. Troubleshooting strategies and action plans
are both integral to problem-solving but serve different roles in the
process. Artifacts are critical elements in both troubleshooting
strategies and action plans as they provide the concrete evidence or
data needed to understand and solve the issue.”
    },
    {
      “role”: “user”,
      “content”: “We received the following issue reported by a
customer: < issue>Inquiries about stuck orders</issue>. This issue is
related to the <component>Inquiries about stuck order</component>
component of the product. DO NOT focus on the <issue>, it is merely
presented to give context to the task. Your task is to create an action
plan to troubleshoot the presented <component>. For example, you may
need to collect logs, or ask the customer for more information. Don't
include customer names or any other sensitive, personal or identifiable
information in the action plan. Don't focus on the <issue> (there is
another AI that does that). Instead, focus on creating a structured
plan that is product agnostic, but specific to the mentioned product
<component>.”
    },
    {
      “role”: “user”,
      “content”: “A troubleshooting strategy is a methodology or
set of guidelines to diagnose and understand an issue. The main aspects
are diagnostic, investigative, and observational. The strategy should
help identify the problem's nature, scope, and cause before any
solution is attempted. The following troubleshooting strategy has been
identified for troubleshooting this product (all components) : 1) Start
by Observing, to determine what the problem is and where we stand 2)
Research prior reports or the product's Knowledge Bases 3) Come up with
a plausible Root Cause Hypothesis 4) Attempt to disprove the RC, if you
can't it means we are on to something 5) Always propose some solution
or workaround as a specific call to action. 6) Communicate in direct,
simple terms. Attempt to resolve the issues in only one communication
to the customer. The following troubleshooting strategy has been
identified for troubleshooting this component: {component} 1) check the
work order management for the stuck order. 2) check for respective API
requests and responses. 3) adjust the values from DB or resubmitting
the work order For Dunning process stuck: Ask customer to mark as
failed/completed. and then to rerun again again reporting how many
entities are picked .”
    },
    {
      “role”: “user”,
      “content”: “Artifacts are essential inputs for the
troubleshooting process. They provide the raw data needed to understand
what is going wrong. Consider what types of artifacts might be relevant
based on the issue being addressed and suggest or require customers to
provide these artifacts as part of the troubleshooting process.
Artifacts are also critical in the action plan phase as they can serve
as benchmarks or evidence of the issue's resolution. The following
artifacts are generally needed from the customer for troubleshooting
this product (for all components) : Logs containing the order details or
the error shown The following artifacts are generally needed from the
customer for troubleshooting this component in particular: {component}
artifacts: Order number SIA ( Service Instance account number) For
Dunning processes : the stuck dunning process number”
    }
  ]
```

The prompt 116 outlines the role and behavior of a technical assistant functioning as an experienced customer support agent. The technical support bot 118 is instructed to prioritize privacy by avoiding the disclosure of sensitive information like application credentials, emails, phone numbers, addresses, or passwords. However, the technical support bot 118 can use customer's first name wherever seems appropriate.

The prompt 116 instructs the technical support bot 118 to provide accurate information and refrain from fabricating answers in cases of uncertainty. For non-English content, technical support bot 118 needs to detect the language, translate the content to English, and then analyze the content. The output is preferably in English language and generally formatted in Markdown unless specified otherwise. The technical support bot 118 needs to avoid unnecessary preambles, acknowledgments of the task type, or postscripts explaining how technical support bot 118 performed the task. The technical support bot 118 is instructed to focus on providing straightforward, matter-of-fact answers based on the given instructions.

The prompt 116 outlines the key elements of the troubleshooting action plan, including a title, immediate steps, investigation process, artifacts to collect, solution development, implementation, and follow-up actions. The technical support bot 118 is instructed to use information about the product component, troubleshooting strategy, and required artifacts to build the troubleshooting action plan. The troubleshooting strategies are described as methodologies for diagnosing the causes of a problem, focusing on identifying the root cause and understanding the issue's context. The troubleshooting action plan is defined as sequences of steps for implementing solutions based on the findings from troubleshooting.

A user prompt presents an issue reported by a customer related to a specific component of a product. The user prompt instructs technical support bot 118 to not focus on the issue itself but rather on creating the troubleshooting action plan. The troubleshooting action plan should be product-agnostic but specific to the component. The user prompt explicitly states to avoid including sensitive or personally identifiable information in the troubleshooting action plan. The user prompt outlines a general troubleshooting strategy and a component-specific strategy. The general strategy involves six steps: observation, research, hypothesis formation, hypothesis testing, proposing solutions, and clear communication. The component-specific strategy provides three steps tailored to the particular component, which involve checking work order management, API requests and responses, and adjusting database values or resubmitting work orders. The user prompt also includes a special note for handling stuck dunning processes. The dunning process is refers to the set of systematic steps taken by businesses to communicate with customers about overdue payments and encourage them to settle outstanding debts.

In the above mentioned prompt, the “<component>Inquiries about stuck order</component>′” part is replaced by the specific issues that the customer is providing through the customer ticket 104. “1) Start by Observing, to determine what the problem is and where we stand 2) Research prior reports or the product's Knowledge Bases 3) Come up with a plausible Root Cause Hypothesis 4) Attempt to disprove the RC, if you can't it means we are on to something 5) Always propose some solution or workaround as a specific call to action. 6) Communicate in direct, simple terms. Attempt to resolve the issues in only one communication to the customer.” is replaced with the product troubleshooting strategies of different product or services with respect to the customer ticket 104. The “{component} 1) check the work order management for the stuck order. 2) check for respective API requests and responses. 3) adjust the values from DB or resubmitting the work order For Dunning process stuck: Ask customer to mark as failed/completed. and then to rerun again again reporting how many entities are picked” is replaced by the specific component troubleshooting strategies for different issues given in the customer ticket 104. The “Logs containing the order details or the error shown” is replaced by artifacts for product as a whole for different issues with respect to the customer ticket 104. The “artifacts: Order number SIA (Service Instance account number) For Dunning processes: the stuck dunning process number” is replaced by artifacts for specific components for different issues with respect to the customer ticket 104.

The output for the abovementioned prompt is:

# Action Plan to Solve Issues Related to Inquiries about Stuck
Orders

| ## | Immediate Steps |
|---|---|
| 1. | **Acknowledge Receipt**: Confirm receipt of the issue report |

to the customer.

| | |
|---|---|
| 2. | **Initial Observation**: Start by observing the symptoms and |

patterns related to the stuck order.

| | |
|---|---|
| ## | Investigation Process |
| 1. | **Work Order Management**: |
| | - Check the work order management system for the stuck order. |
| | - Identify any discrepancies or anomalies in the order status. |
| 2. | **API Requests and Responses**: |
| | - Review the respective API requests and responses associated |

with the order.

| | |
|---|---|
| | - Look for any error messages or failed responses. |
| 3. | **Database Adjustments**: |
| | - If necessary, adjust the values in the database or resubmit |

the work order.

| | |
|---|---|
| 4. | **Dunning Process (if applicable)**: |
| | - Ask the customer to mark the dunning process as failed or |

completed.

- Instruct the customer to rerun the process and report how

many entities are picked.

| | |
|---|---|
| ## | Artifacts |

```
  ### General Artifacts Needed:
  - Logs containing the order details or the error shown.
  ### Specific Artifacts for This Component:
  - Order number.
  - Service Instance Account (SIA) number.
  - For Dunning processes: the stuck dunning process number.
```

| | |
|---|---|
| ## | Solution Development |
| 1. | **Hypothesis Formation**: |
| | - Based on the investigation, form a plausible root cause |

hypothesis.

| | |
|---|---|
| 2. | **Hypothesis Testing**: |
| | - Attempt to disprove the root cause hypothesis. If it cannot |

be disproven, proceed with the solution.

| | |
|---|---|
| 3. | **Propose Solutions**: |
| | - Develop a solution or workaround based on the identified |

root cause.

- Ensure the solution is actionable and can be communicated in

direct, simple terms.

| | |
|---|---|
| ## | Implementation |
| 1. | **Execution**: |
| | - Implement the solution or workaround. |
| | - Ensure all necessary adjustments are made in the work order |

management system, API configurations, or database.

| | |
|---|---|
| 2. | **Responsibility**: |
| | - Assign specific tasks to team members responsible for each |

part of the implementation.

| | |
|---|---|
| ## | Follow-up |
| 1. | **Verification**: |
| | - Verify that the solution has resolved the issue. |
| | - Check for any residual issues or side effects. |
| 2. | **Customer Communication**: |
| | - Communicate the resolution to the customer. |
| | - Provide any necessary instructions or information for future |

reference.

| | |
|---|---|
| 3. | **Documentation**: |
| | - Document the issue, investigation process, solution, and |

follow-up actions for future reference.

- Update the knowledge base with the resolved issue and steps

taken.
By following this action plan, we can systematically address and
resolve issues related to inquiries about stuck orders, ensuring a
thorough and efficient troubleshooting process.

In operation 210, the prompt generator 114 provides the generated prompt 116 and other data extracted by the customer support system 108 from the user data 106 and the TAP database 112 to the technical support bot 118. The prompt 116 created by the prompt engineers and modified by the prompt generator 114 is transferred to the technical support bot 118. The transferred prompt 116 includes both the user prompt and the system prompt. The data from the user data 106 includes customer-provided logs, input files, and past tickets, and the data from TAP database 112 includes issue description, troubleshooting strategy, and artifacts needed.

The exemplary troubleshooting action plan generation system 100 where the TAP database 112 actively stores the output generated by the technical support bot 118. The TAP database 112 serves as a repository for the solutions and insights derived from previous troubleshooting efforts. When similar customer ticket 104 arises, the exemplary troubleshooting action plan generation system 100 retrieves and utilizes the relevant stored output from the TAP database to address these issues.

In operation 212, the technical support bot 118 generates troubleshooting action plans via an action plan generator 126 present inside the technical support bot 118. Wherein the technical support bot 118 also includes a query augmentation artificial intelligence model 120, a ticket summarizer AI model 122, and an attachment analysis LLM 124 for supporting the generation of troubleshooting action plans.

The troubleshooting action plan is a step-by-step guide designed to systematically resolve the customer ticket 104. The troubleshooting action plan lays out clear actions to investigate the issue and determine the root cause. Example for the troubleshooting action plan for an issue product “aurea-integrations-actional” for a component “Install/Upgrade”

```
  - Installation logs: These logs can provide detailed information
about the installation process, including any errors or warnings that
occurred.
  - System Information: Details about the customer's system,
including the operating system, Java version, and any other relevant
software versions.
  - Error Messages: If any error messages were displayed during the
installation or upgrade process, these should be collected.
  - Screenshots: If possible, screenshots of any errors or issues
encountered during the installation or upgrade process can be helpful.
  - Version Information: The specific versions of the software that
the customer is upgrading from and to.
  Based on the above information, the following action plan can be
created:
  # Action Plan to Solve issues related to Install / Upgrade
```

| ## | Immediate Steps |
|---|---|
| 1. | Ask the customer to provide the necessary artifacts, including |

installation logs, system information, error messages, screenshots, and
version information.

| | |
|---|---|
| 2. | Verify the customer's current system configuration, including |

the versions of Java, ActiveMQ, and RedHat Linux they are using.

| | |
|---|---|
| ## | Investigation Process |
| 1. | Review the provided artifacts to understand the issue in |

detail.

| | |
|---|---|
| 2. | Consult the product's knowledge base and any previous reports |

of similar issues.

| | |
|---|---|
| 3. | Check the compatibility of the customer's current system |

configuration with the latest version of the software.

| | |
|---|---|
| ## | Artifacts |
| 1. | Collect all the artifacts provided by the customer. |
| 2. | Request any additional information or artifacts as needed |

based on the investigation.

| | |
|---|---|
| ## | Solution Development |
| 1. | Based on the investigation, develop a solution to the issue. |

This could involve recommending a specific version of Java, ActiveMQ,
or RedHat Linux that is compatible with the latest version of the
software.

| | |
|---|---|
| 2. | If the primary solution is not feasible, consider alternative |

solutions such as using a different version of the software or changing
the system configuration.

| | |
|---|---|
| ## | Implementation |
| 1. | Communicate the solution to the customer in clear, simple |

terms.

| | |
|---|---|
| 2. | Guide the customer through the process of implementing the |

solution, providing detailed instructions as necessary.

| | |
|---|---|
| 3. | Ensure the customer understands any changes they need to make |

to their system configuration.

| | |
|---|---|
| ## | Follow-up |
| 1. | After the solution has been implemented, follow up with the |

customer to ensure the issue has been resolved.

| | |
|---|---|
| 2. | Ask the customer to provide any relevant artifacts to confirm |

the successful implementation of the solution.

| | |
|---|---|
| 3. | If the issue persists, repeat the process as necessary until |

the issue is resolved.

The query augmentation artificial intelligence model 120 improves and enhances the customer ticket 104 to generate more accurate, relevant, and comprehensive responses. By expanding or refining the user data 106, the action plan generator 126 can better understand the customers intent and retrieve more detailed information. The query augmentation artificial intelligence model 120, analyzes the original customer ticket 104, identifies missing elements, ambiguities, or vague terms, and then adds relevant keywords, context, or details to enhance the customer ticket 104. The query augmentation artificial intelligence model 120 processes the customer ticket 104 more effectively, improving the quality of the response. Techniques such as rephrasing, adding synonyms, or incorporating related concepts are often used by the query augmentation artificial intelligence model 120 to make the customer ticket 104 more complete and aligned with the customer's intent.

The ticket summarizer AI model 122 automatically summarizes customer ticket 104. By processing the text within the customer ticket 104, the ticket summarize LLM 122 identifies key information, such as the nature of the issue, actions taken, and any outcomes, to generate a concise summary. This allows the action plan generator 126 teams to quickly understand the issues. The ticket summarizer AI model 122 reads the content of the customer ticket 104, analyzes the customer ticket 104, and extracts the most critical points.

The attachment analysis LLM 124 automatically reviews, interprets, and extracts key information from attachments such as customer provided logs, input files, past tickets, or other communications. The attachment analysis LLM 124 processes the content within the attachments, analyzes its structure, and generates insights or summaries based on the material provided.

The customer support system 108 fetches the prompt 116 and other data from the user data 106 and the TAP database 112, then passes it to the technical support bot 118. The query augmentation artificial intelligence model 120 processes the information, followed by the ticket summarizer AI model 122 and the attachment analysis LLM 124, where the customer ticket 104 is modified. Finally, the customer ticket 104 is shared with the action plan generator 126.

The action plan generator 126 generates a troubleshooting action plan for the customer ticket 104, having issues related to one or more components of a product or service. The action plan generator 126 analyzes the details of the customer ticket 104 and identifies the necessary steps to resolve the issues in the customer ticket 104 efficiently. In operation 214, the generated troubleshooting action plan is passed on to the user.

Some of the examples are provided below:

### Example 1

```
  Product NewNet
  Customer Input:
  i had an issue in common config files
  * synching does not take place on other routers when we have applied on one rtr
  * in normal case scenarios, when we change common config file on one cloud
router, common config files on all other cloud routers should be changed but the case
now that changing common config file on one cloud router does not reflect on all other
routers
  Classified as
  Inquiries about configuration changes - Inquiries related to how to perform a
certain change or modify certain parameter
  Body:
  {
        “query” : “ had an issue in common config files * synching does not take
place on other routers when we have applied on one rtr * in normal case scenarios, when
we change common config file on one cloud router, common config files on all other
cloud routers should be changed but the case now that changing common config file on
one cloud router does not reflect on all other routers”
  }
  Action Plan Endpoint Response:
  {
    “status”: “Completed”,
    “progress”: “100%”,
    “response”: “# Action Plan to Solve issues related to Inquiries about
Configuration changes or issues\n\n### Immediate Steps\n1. Acknowledge the receipt of
the issue reported by the customer.\n2. Review the details of the issue, specifically
focusing on the changes made to the common_config file.\n3. Request the necessary
artifacts from the customer: \n - /var/log/messages\n - tp_walkall command output\n
- common_config.txt file from the /usr/TextPass/etc directory\n - hostname_config.txt
file from the /usr/TextPass/etc directory\n\n## Investigation Process\n1. Analyze the
provided artifacts to understand the current configuration and any changes made.\n2.
Compare the current configuration with the default settings to identify any
discrepancies.\n3. Check if the changes made by the customer are in line with the
operator manuals.\n4. Investigate if the changes made are being overwritten by the
common_config of the MGR server.\n\n## Artifacts\n1. Collect the above-mentioned
artifacts from the customer.\n2. Document all findings and observations during the
investigation process.\n\n## Solution Development\n1. Based on the findings from the
investigation, develop a solution to ensure the changes made to the common_config file
are not being overwritten.\n2. If the primary solution is not feasible, consider alternatives
such as modifying the MGR server's common_config file or providing a
workaround.\n\n## Implementation\n1. Communicate the solution to the customer in
simple, direct terms.\n2. Guide the customer through the implementation process,
ensuring they understand each step.\n3. If necessary, arrange for a technical specialist to
assist the customer with the implementation.\n\n### Follow-up\n1. After the solution has
been implemented, request the customer to confirm if the issue has been resolved.\n2. If
the issue persists, revisit the investigation process and consider other potential causes.\n3.
Once the issue is resolved, document the process and outcome for future reference.”,
    “product_tag”: “newnet”,
    “component”: “Inquiries about Configuration changes or issues.”,
    “strategies”: {
      “strategy”: {
        “all_components”: null,
        “component”: null
      },
      “artifacts”: {
        “all_components”: null,
        “component”: null
      }
    },
    “source”: “TAP”,
    “cached_response”: true,
    “AI_usage”: [
      {
        “model”: “claude-3-sonnet-20240229”,
        “prompt_tokens”: 1178,
        “completion_tokens”: 11,
        “cost”: 0.003699,
        “modules”: [
          “TAP_component_classification”
        ]
      },
      {
        “total_cost”: 0.003699
      }
    ],
    “started_at”: “2024-09-06T04:11:53.797936”,
    “finished_at”: “2024-09-06T04:11:58.087135”,
    “execution_time”: “4.29”
  }
  Entry in TAP database 112
```

### Example 2

```
  Product NewNet
  Customer Query
* LGP diskspace reaches high values fast, and there is no additional data added so we
need to know the root cause and how to solve it
  * all LGPs on RMD-cloud LGP1-LGP2-LGP3 & LGP4
  Classified as
  disk space full - issues caused by /var/Textpass full or 100% diskspace on MGR
or STV
  Body:
  {
        ″query″ : ″ **Subject:** LGP Disk Space High Values\n\n**Issue
Description:**\n\nI am experiencing an issue where the disk space on all LGPs (LGP1,
LGP2, LGP3, and LGP4) in our RMD-cloud environment is reaching high values very
quickly, despite no additional data being added. I have provided the output of the ‘df -kh‘
and ‘tp_status‘ commands for all traffic nodes and LGPs, as requested. Additionally, I
attempted to run the ‘tp_install_mgr --check‘ command on the MGR CLI, but
encountered connection errors. We need to identify the root cause of this rapid disk space
consumption and find a solution to prevent it from happening.″
  }
  Action Plan Endpoint Response:
  {
    ″status″: ″Completed″,
    ″progress″: ″100%″,
    ″response″: ″# Action Plan to Solve issues related to disk space full\n\n##
Immediate Steps:\n1. Acknowledge the customer's issue and reassure them that we will
work towards a resolution.\n2. Request the necessary artifacts from the customer:\n -
/var/log/messages\n - Output of‘df -kh‘ command\n - Output of‘du -ah /<mount> |
sort -rh | head -n 20‘ command\n - Output of‘lsof | grep ′(deleted)′‘ command\n3.
Verify the version of the product installed.\n\n## Investigation Process:\n1. Analyze the
/var/log/messages for any error messages or warnings related to disk space.\n2. Review
the output of‘df -kh‘ command to identify the mount with high disk usage.\n3. Use the
output of‘du -ah /<mount> | sort -rh | head -n 20‘ command to identify the directories or
files consuming the most disk space.\n4. Check the output of‘lsof | grep ′(deleted)′‘
command to find any deleted files that are still in use and occupying space.\n\n##
Artifacts:\n1. Collect the outputs of the commands run during the investigation
process.\n2. Keep a record of any error messages or warnings found in
/var/log/messages.\n\n## Solution Development:\n1. If the issue is due to old logs,
propose a solution to delete or archive these logs.\n2. If the issue is due to lack of disk
space, suggest increasing the disk space on the partition.\n3. If the issue is due to deleted
files still in use, propose a solution to free up this space.\n\n## Implementation:\n1.
Guide the customer through the solution steps, providing clear and concise
instructions.\n2. Monitor the implementation process, providing assistance as
needed.\n\n## Follow-up:\n1. After the solution has been implemented, request the
customer to run the ‘df -kh‘ command again to verify that the disk space issue has been
resolved.\n2. If the issue persists, revisit the investigation process and consider alternative
solutions.\n3. Once the issue is resolved, provide preventive measures to avoid similar
issues in the future.″,
    ″product_tag″: ″newnet″,
    ″component″: ″disk space full″,
    ″strategies″: {
      ″strategy″: {
        ″all_components″: null,
        ″component″: null
      },
      ″artifacts″: {
        ″all_components″: null,
        ″component″: null
      }
    },
    ″source″: ″TAP″,
    ″cached_response″: true,
    ″AI_usage″: [
  {
        ″model″: ″claude-3-sonnet-20240229″,
        ″prompt_tokens″: 1258,
        ″completion_tokens″: 6,
        ″cost″: 0.003864,
        ″modules″: [
          ″TAP_component_classification″
        ]
      },
      {
        ″total_cost″: 0.003864
      }
    ],
    ″started_at″: ″2024-09-06T04:23:15.455132″,
    ″finished_at″: ″2024-09-06T04:23:19.859421″,
    ″execution_time″: ″4.40″
  }
  Entry in TAP database 112
```

### Example 3

```
  Product: Kerio Connect
  Customer Query
  * In Kerio Spam Filter the custom rules are not working. Every rule is unused.
Have also cleared all rules an started from scratch, but still the rules are not considered,
when a message is received.
  Classified As:
  Spam and Malware issues - Problems with the Kerio Connect Anti-Spam feature,
SpamAssasin plugin or Spam Rating feature, Greylisting, Spam Repellent feature, SPF
configuration, custom spam rules. This category doesn't cover false positives and false
negatives.
  Body:
  {
        “query” : “ **Subject:** Custom rules not working\n\n**Issue
description:**\n\nI am experiencing an issue with the custom rules in the Kerio Spam
Filter not being applied. Despite clearing all rules and starting from scratch, the rules
remain unused when a message is received. I have provided debug logs and a screenshot
showing that a message from an external email address with a corresponding custom rule
to add a spam score is still not being processed. The rule is marked as \“unused.\” I need
assistance in resolving this issue as it is crucial for our email filtering to function
correctly.”
  }
  Action Plan Endpoint Response:
  {
    “status”: “Completed”,
    “progress”: “100%”,
    “response”: “# Action Plan to Solve issues related to Spam and Malware
issue\n\n## Immediate Steps\n1. Ask the customer to provide the Support Information
File, Mail log, Spam log, and Debug logs with the Spam Filter, SpamAssassin
Processing, or Kerio Anti-spam processing enabled.\n2. Request email samples that are
causing the issue.\n3. Review the overall spam configuration of Kerio Connect.\n\n##
Investigation Process\n1. Start by observing the problem, its symptoms, and patterns.\n2.
Research prior reports or the product's Knowledge Bases.\n3. Analyze the provided logs
and email samples to understand the problem's context.\n4. Review the spam
configuration of Kerio Connect in all potential areas: Kerio Connect Anti-Spam advanced
feature, SpamAssasin plugin or Spam Rating feature, Greylisting, Spam Repellent
feature, SPF configuration, blacklists, custom spam rule configuration.\n5. Based on the
collected artifacts and configuration review, come up with a plausible Root Cause
Hypothesis.\n\n## Artifacts\n1. Support Information File\n2. Mail log\n3. Spam log\n4.
Debug logs with the Spam Filter, SpamAssassin Processing, or Kerio Anti-spam
processing enabled.\n5. Email samples\n\n## Solution Development\n1. If the root cause
is identified, develop a solution that addresses the root cause.\n2. If the root cause is not
identified, develop potential alternatives that could solve the problem.\n3. If the issue is
related to the false detection of legitimate emails as malware/phishing by the BitDefender
(BD) Anti-Spam engine, follow the specific handling procedure.\n\n##
Implementation\n1. Implement the developed solution or alternative solutions.\n2. If the
issue is related to the BD Anti-Spam engine, submit the sample to the BitDefender
team.\n3. Monitor the system to ensure the solution is working as expected.\n\n##
Follow-up\n1. Ask the customer to confirm if the issue has been resolved.\n2. If the issue
persists, repeat the process or escalate the issue to a higher authority.\n3. If the issue is
resolved, document the problem and the solution for future reference.”,
    “product_tag”: “aurea_kerio_connect”,
    “component”: “Spam and Malware issue”,
    “strategies”: {
      “strategy”: {
        “all_components”: “1) Start by Observing, to determine what the problem
is and where we stand\n2) Research prior reports or the product's Knowledge Bases\n3)
Come up with a plausible Root Cause Hypothesis\n4) Attempt to disprove the RC, if you
can't it means we are on to something\n5) Always propose some solution or workaround
as a specific call to action. \n6) Communicate in direct, simple terms. Attempt to resolve
the issues in only one communication to the customer.”,
        “component”: “1. Review the overall spam configuration of Kerio Connect
in all potential areas:Kerio Connect Anti-Spam advanced feature, SpamAssasin plugin or
Spam Rating feature, Greylisting, Spam Repellent feature, SPF configuration, blacklists,
custom spam rule configuration \n2. Review mail logs, spam logs, debug logs and email
samples\n3. Based on all the above, identify the specific component causing issues; it can
be specifically indicated by the customer, otherwise, it can be identified from logs or
email samples.\n4. The issue can usually be solved by fine-tuning the configuration of the
embedded anti-spam features in Kerio Connect. However, if no ideal configuration can
be found, specific hosts or senders can be subjected to the desired behavior through the
configuration of custom rules.\n5. A very specific case in this component is the false
detection of legitimate emails as malware/phishing by the BitDefender (BD) Anti-Spam
engine, which is bundled in the Kerio Anti-spam advanced feature, and results in the
emails being rejected (they never reach the recipient mailbox). This type of detection is
NOT subject to the aforementioned custom rules configuration, and it requires a specific
handling: https://support.kerioconnect.gfi.com/hc/en-us/articles/360015194379-
Legitimate-Emails-Rejected-as-Malware-or-Phishing-Spam \n- customer needs to adjust
the Kerio mailserver so that a sample email is received\n- customer will provide the
sample email to us\n- we analyze the sample email, specifically the X-Kerio-Anti-Spam
(the header used by the BitDefender Anti-Spam engine)\n- if the X-Kerio-Anti-Spam
header reveals that the BD engine incorrectly blocked the email as phishing/malware, we
submit the sample to the BitDefender team”
      },
      “artifacts”: {
        “all_components”: “Support Information File”,
        “component”: “Support information file\n- Mail log\n- Spam log\n- Debug
logs with the Spam Filter, SpamAssassin Processing, or Kerio Anti-spam processing
enabled (depending on the faulty feature).\n- Email samples”
      }
    },
    “source”: “TAP”,
    “cached_response”: true,
    “AI_usage”: [
      {
        “model”: “claude-3-sonnet-20240229”,
        “prompt_tokens”: 1665,
        “completion_tokens”: 9,
        “cost”: 0.00513,
        “modules”: [
          “TAP_component_classification”
        ]
      },
      {
        “total_cost”: 0.00513
      }
    ],
    “started_at”: “2024-09-06T04:36:15.967511”,
    “finished_at”: “2024-09-06T04:36:19.443124”,
    “execution_time”: “3.48”
  }
  Entry in TAP database 112
```

### Example 4

```
  Product: Kerio Connect
  Customer Query
  * When saving mails as drafts, Umlaute will break. When writing and instantly
sending, there will be no issue. Whenever I am saving a Mail in my drafts folder, the
Umlaute will break after swapping to another folder an back to drafts.My EMail Client is
Outlook using KOFF, the issue does not persist when writing and Saving mails in Drafts
using Webmail.Using Web Mail or Outlook's Rich Text isn't an Option, as this
contradicts the customers workflow.International Options in Outlook are configured
Right and are also usint UTF-8
  Classified As:
  Outlook client issues - Problems with the usage of the Outlook Windows client
via the KOFF (Kerio Outlook Connector) plugin, Exchange ActiveSync (EAS) protocol,
IMAP or POP3 protocol.
  Body:
  {
        “query” : “ **Subject:** Umlaute break when saving drafts\n\n**Issue
description:**\n\nWhen saving emails as drafts in Outlook using KOFF, Umlaut
characters break. This issue does not occur when writing and instantly sending emails or
when using Webmail. However, using Webmail or Outlook's Rich Text is not an option
as it contradicts our workflow. We have tried adjusting international options to UTF-8
and automatic encoding, but the problem persists. We are using Windows 10 and Outlook
configured with KOFF. Screenshots of the broken emails and the KOFF version have
been provided previously. Please assist in resolving this issue.”
  }
  Action Plan Endpoint Response:
  {
    “status”: “Completed”,
    “progress”: “100%”,
    “response”: “# Action Plan to Solve issues related to Outlook KOFF\n\n##
Immediate Steps:\n1. Acknowledge the customer's issue and reassure them that we will
work towards a resolution.\n2. Ask the customer to provide the necessary artifacts:
Support Information File, KOFF store Debug logs, and Server debug logs with KOFF
debug messages enabled.\n3. Confirm the versions of KOFF, Outlook, and Windows that
the customer is using.\n4. Check if user profiles are on Terminal Server.\n\n##
Investigation Process:\n1. Analyze the provided artifacts to understand the nature of the
issue.\n2. Research any similar issues in the product's Knowledge Bases or prior
reports.\n3. Develop a Root Cause Hypothesis based on the information gathered.\n4.
Test the hypothesis by trying to disprove it. If it cannot be disproven, it may be the
correct cause.\n\n## Artifacts:\n1. Support Information File\n2. KOFF store Debug
logs\n3. Server debug logs with KOFF debug messages enabled\n\n## Solution
Development:\n1. Based on the findings from the investigation, develop a solution to
address the issue.\n2. Consider alternative solutions in case the primary solution is not
feasible.\n3. Propose the solution or workaround to the customer.\n\n##
Implementation:\n1. Provide the customer with detailed steps to implement the
solution.\n2. If necessary, involve the technical team to assist with the
implementation.\n3. Ensure the solution is implemented correctly and fully.\n\n##
Follow-up:\n1. After the solution has been implemented, follow up with the customer to
confirm if the issue has been resolved.\n2. If the issue persists, revisit the investigation
process and develop a new solution.\n3. If the issue is resolved, document the process for
future reference and to assist with similar issues in the future.”,
    “product_tag”: “aurea_kerio_connect”,
    “component”: “Outlook KOFF”,
    “strategies”: {
      “strategy”: {
        “all_components”: “1) Start by Observing, to determine what the problem
is and where we stand\n2) Research prior reports or the product's Knowledge Bases\n3)
Come up with a plausible Root Cause Hypothesis\n4) Attempt to disprove the RC, if you
can't it means we are on to something\n5) Always propose some solution or workaround
as a specific call to action. \n6) Communicate in direct, simple terms. Attempt to resolve
the issues in only one communication to the customer.”,
        “component”: “1. Confirm the KOFF version in use\n2. Confirm the
Outlook version (2016, 2019, O365 etc) and edition (Office Professional, Office
Home&Business etc)\n3. Confirm Windows version\n4. Confirm if user profiles are on
Terminal Server\n5. One of the most common root causes for KOFF issues is local
corruption of the account profile. Another common root cause is serverside user profile
corruption. These 2 should first be eliminated as potential root causes.”
      },
      “artifacts”: {
        “all_components”: “Support Information File”,
        “component”: “Support information file\r\n- KOFF store Debug logs\r\n-
Server debug logs with KOFF debug messages enabled”
      }
    },
    “source”: “TAP”,
    “cached_response”: true,
    “AI_usage”: [
      {
        “model”: “claude-3-sonnet-20240229”,
        “prompt_tokens”: 1693,
        “completion_tokens”: 7,
        “cost”: 0.005184,
        “modules”: [
          “TAP_component_classification”
        ]
      },
      {
        “total_cost”: 0.005184
      }
    ],
    “started_at”: “2024-09-06T04:44:33.173316”,
    “finished_at”: “2024-09-06T04:44:37.566703”,
    “execution_time”: “4.39”
  }
```

The action plan generator 126 uses fallback mechanisms when unable to generate specific troubleshooting strategies. The fallback mechanism is the method of providing general strategies to solve the customer ticket 104.

Pseudocode for generating the action plan is given below:

function generateActionPlan(userInput):
issue, component = parseInput(userInput)
strategy = getStrategy(component)
actionPlan = formulateActionPlan(strategy, issue)
return actionPlan

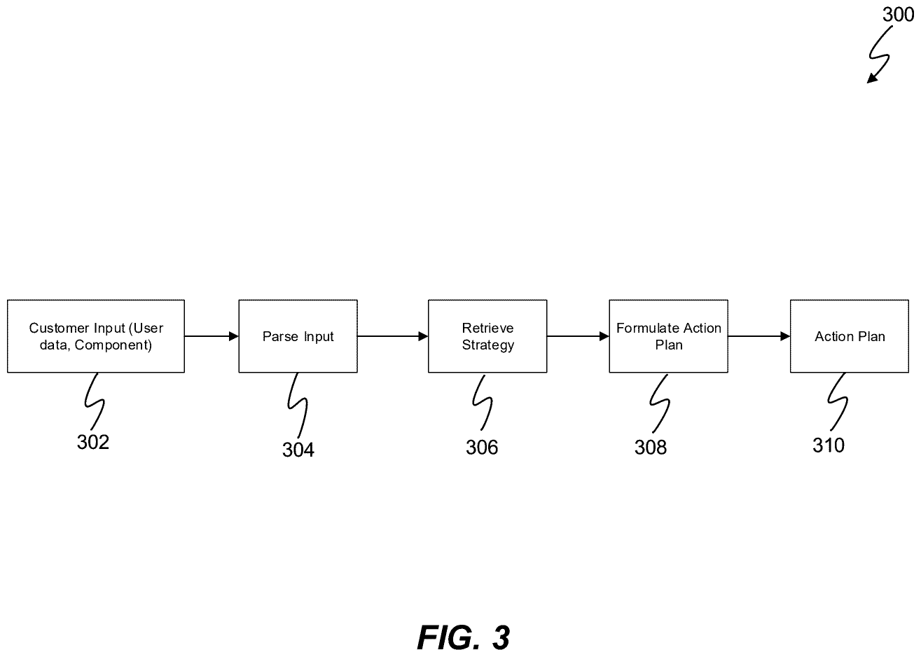

FIG. 3 depicts a block diagram 300 for the exemplary troubleshooting action plan generation method, which is an embodiment of the exemplary troubleshooting action plan generation method of FIG. 2. The customer input 302, which receives input from the customer, includes a description of the issue and the user data 106. The customer input 302 serves as the starting point for the entire workflow. Next mapping 304, where the components of the product or service from the customer input 302 is mapped with the components in the TAP database 112. After mapping 304, the exemplary troubleshooting action plan generation method starts retrieving strategy 306. The retrieve strategy 306 step extracts data from the TAP database 112, such as issue description, troubleshooting strategy, and artifacts needed.

The exemplary troubleshooting action plan generation method then advances to formulating an action plan 308. In formulating an action plan 308, the prompt generator 114 generates prompt 116 and transfers the prompt 116 to the technical support bot 118. The technical support bot 118 includes the query augmentation artificial intelligence model 120, the ticket summarizer AI model 122, and the attachment analysis LLM 124.

The query augmentation artificial intelligence model 120 processes the information, followed by the ticket summarizer AI model 122 and the attachment analysis LLM 124, where the customer ticket 104 is modified. Finally, the customer ticket 104 is shared with the action plan generator 126. The action plan generator 126 generates a troubleshooting action plan for the customer ticket 104, having issues related to one or more components of a product or service. Finally, the action plan is created at 310.

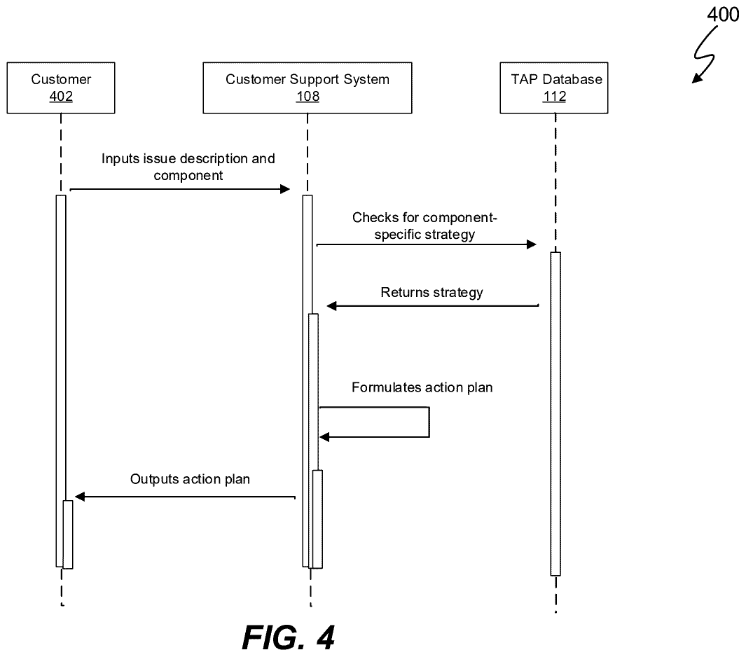

FIG. 4 depicts a sequence diagram 400 for the exemplary troubleshooting action plan generation system 100, which is an embodiment of the exemplary troubleshooting action plan generation system 100 of FIG. 1. A customer 402 initiates the process by providing the exemplary troubleshooting action plan generation system 100 with an issue description. The issue description serves as the starting point for the exemplary troubleshooting action plan generation system 100 to understand the issues. Once the customer support system 108 receives the input, the customer support system 108 interacts with the TAP database 112 to determine if there is an existing strategy related to the component of a product or service. This step allows the exemplary troubleshooting action plan generation system 100 to leverage pre-existing knowledge or frameworks that could assist in resolving the issue efficiently.

The TAP database 112 responds by returning a strategy specific to the component of a product or service if one exists. This strategy is a structured set of guidelines or a predefined approach based on prior cases or established best practices. With the strategy specific returned by the TAP database 112, the customer support system 108, along with the technical support bot 118, processes the information and formulates troubleshooting action plan. The troubleshooting action plan integrates the customers input with the strategy, tailoring a specific solution to address the current issue. Finally, the customer support system 108 outputs this troubleshooting action plan to the customer, providing clear instructions or steps to resolve the issues.

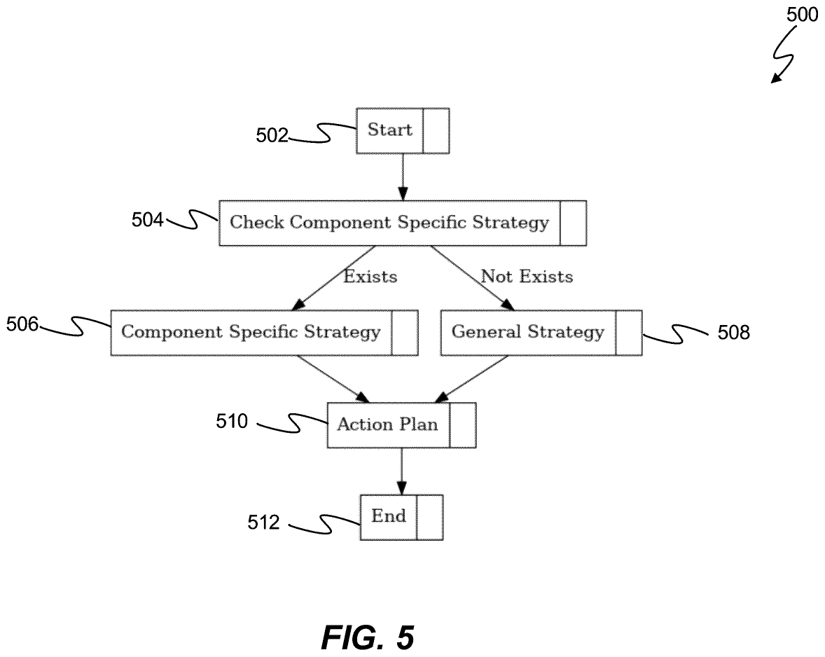

FIG. 5 depicts a flow diagram 500 for a method of selection between component-specific strategies and general strategies, which is an embodiment of the exemplary troubleshooting action plan generation method of FIG. 2. The component-specific strategies is particular strategies for a component of a product or service. The general strategies are the basic strategies created for troubleshooting the general issues of the product or service.

The flow diagram for the dynamic selection between component-specific strategies and general strategies begins at a start node 502, where the exemplary troubleshooting action plan generation method is ready to receive inputs for generating troubleshooting action plan. The method of selection between the component-specific strategies and the general strategies then moves to the next step, A check component-specific strategy 504 node, where the tailored troubleshooting action plan is checked for the one or more competent of the product or system in TAP database 112. At the check component-specific strategy 504 node, a decision is made for following different directions If the component-specific strategy exists, the exemplary troubleshooting action plan generation method follows the path leading to the component-specific strategy 506 node. Where the component-specific strategies are fetched from the TAP database 112. If no component-specific strategies is available, the exemplary troubleshooting action plan generation method follows the Not Exists path to the general strategy 508 node. In this case, the exemplary troubleshooting action plan generation method defaults to a more general set of troubleshooting action plan that can apply to various product or services.

In both the component-specific strategy 506 node and the general strategy 508 node, the exemplary troubleshooting action plan generation method eventually formulates an action plan 510. Finally, the method of selection between the component-specific strategies and the general strategies concludes at the end 512 node after the troubleshooting action plan is generated.

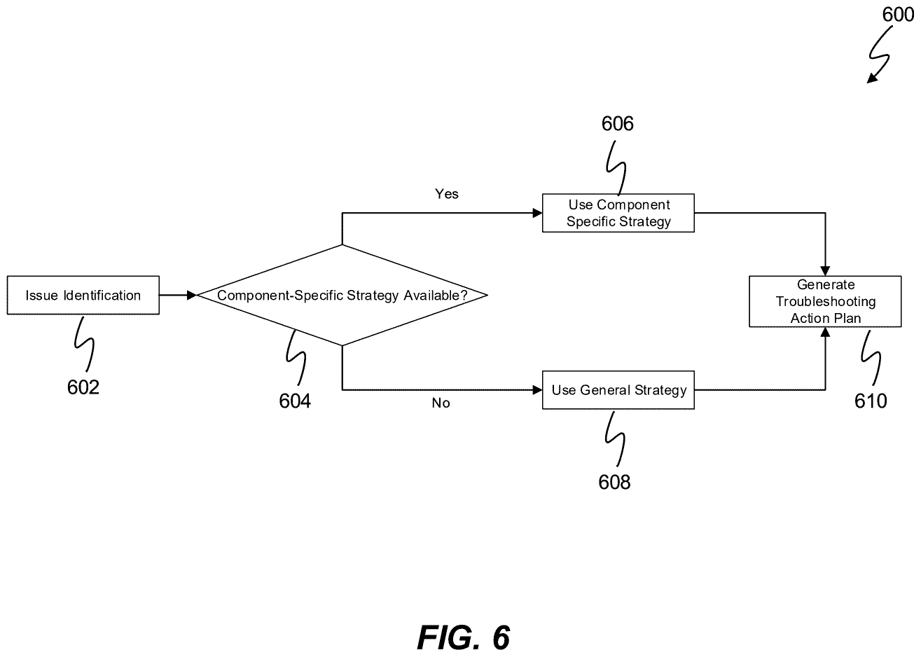

FIG. 6 depicts a flow diagram 600 from issue identification to the generation of troubleshooting action, which is an embodiment of the exemplary troubleshooting action plan generation method 200 of FIG. 2. The flow diagram starts with an issue identification step 602. Where one or more issues related to one or more components of a product or service is identified and mapped with the component in the TAP database 112. The mapping module 110 maps the issues identified with the components in the TAP database 112. In the next step, 604 checks component-specific strategy 504 is available in TAP database 112. The 604 step determines whether to go for component-specific strategy 506 or general strategy 508 node.

If component-specific strategy 506 is found, then flow moves with step 606 with component-specific strategy 506. If component-specific strategy 504 is not found, then flow moves with step 608 by using general strategy 508. In both cases, whether the flow moves in step 606, component-specific strategy 504 or 608, general strategy 508, the flow ultimately arrives at step 610, the generated troubleshooting action plan.

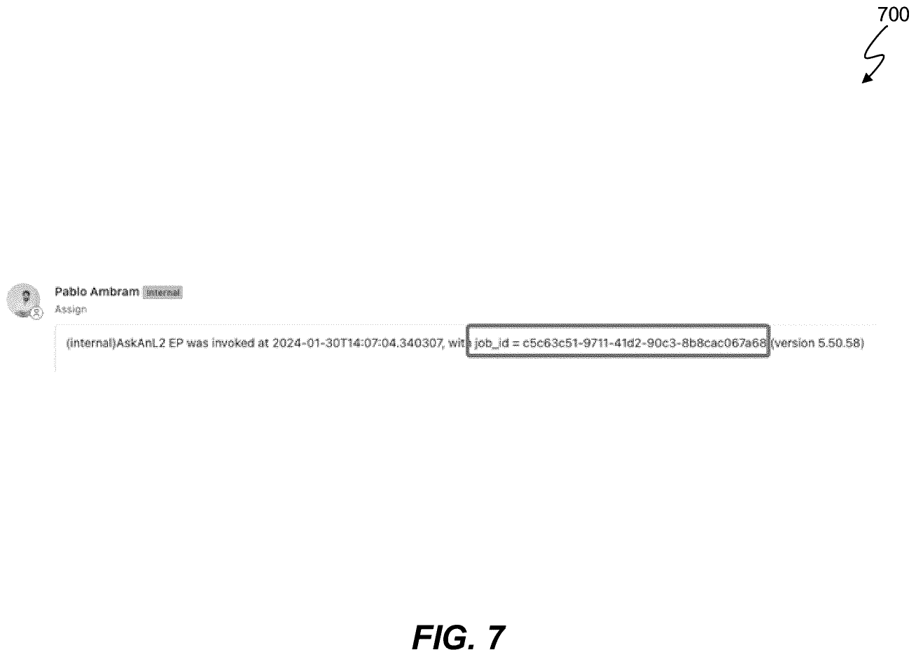

FIG. 7 depicts a system log entry 700. The system log entry has recorded the invocation of an endpoint, showing the precise timestamps and associated identifiers. The endpoint is a specific URL or address within a web service or API (application programming interface) where a client such as a browser, app, or other service can interact with the server. The system log entry also includes the software version used during the operation. The system log entry helps track when and how the endpoint was accessed, providing crucial details for the exemplary troubleshooting action plan generation system 100 monitoring and troubleshooting.

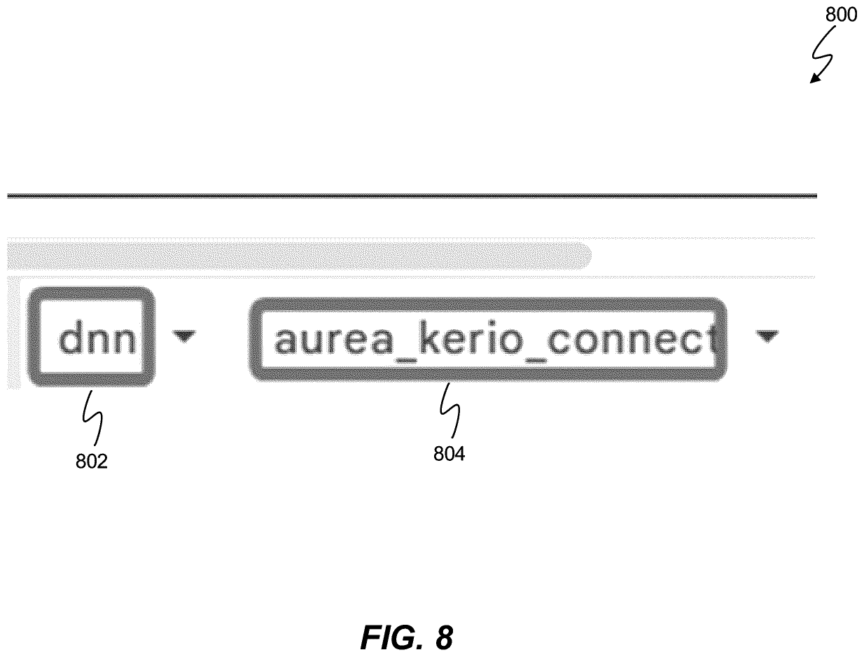

FIG. 8 depicts an exemplary interface 800 showing list of products or services in a user interface of the TAP database 112 800. The TAP database 112 displays a list of products or services at the bottom of the user interface, including examples like ‘dnn’ 802 and ‘aurea_kerio_connect’ 804.

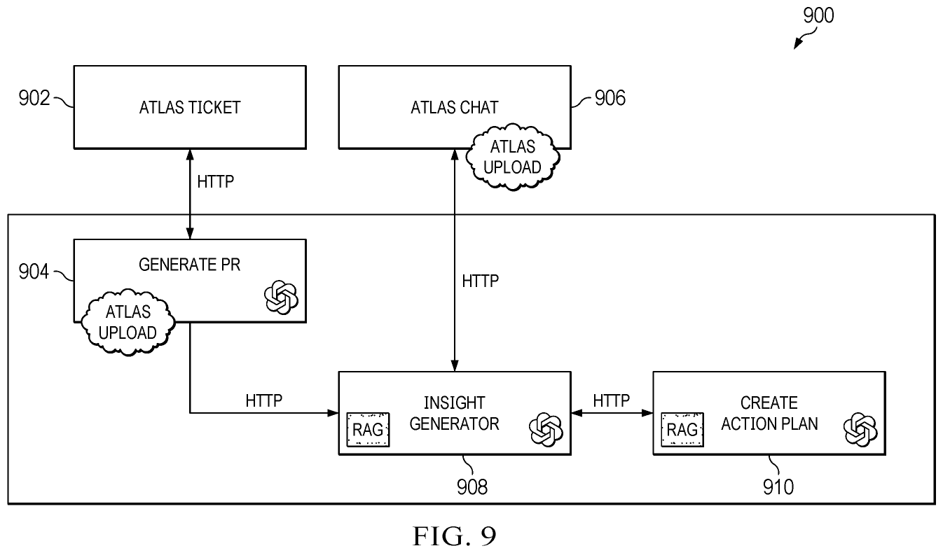

FIG. 9 depicts a flow chart 900 of a process and interactions between different components in the exemplary troubleshooting action plan generation method, which is an embodiment of the exemplary troubleshooting action plan generation method 200 of FIG. 2. In step 902, an Atlas ticket, which can also be referred to as the ticket management platform 102, collects input from the customer and creates customer ticket 104. The Atlas ticket also collects the user data 106. In step 904, a generate PR (Pull Request) endpoint, is responsible for creating pull requests for resolving a ticket and personalizing the troubleshooting action plan.

In step 906, an Atlas chat allows real-time communication, enabling customers to interact with the Atlas system through chat functionality. In step 908, an insight generator is used to get a troubleshooting action plan. In step 910, the action plan generator 126 is used for the generation of troubleshooting action plans. The action plan generator 126 uses the technical support bot 118 for the generation of troubleshooting action plans. The steps 902, 904, 906, 908, and 910 communicate with each other through HTTP (hypertext transfer protocol). In at least one embodiment, the steps 902, 904, 906, 908 and 910 can work in different sequences.

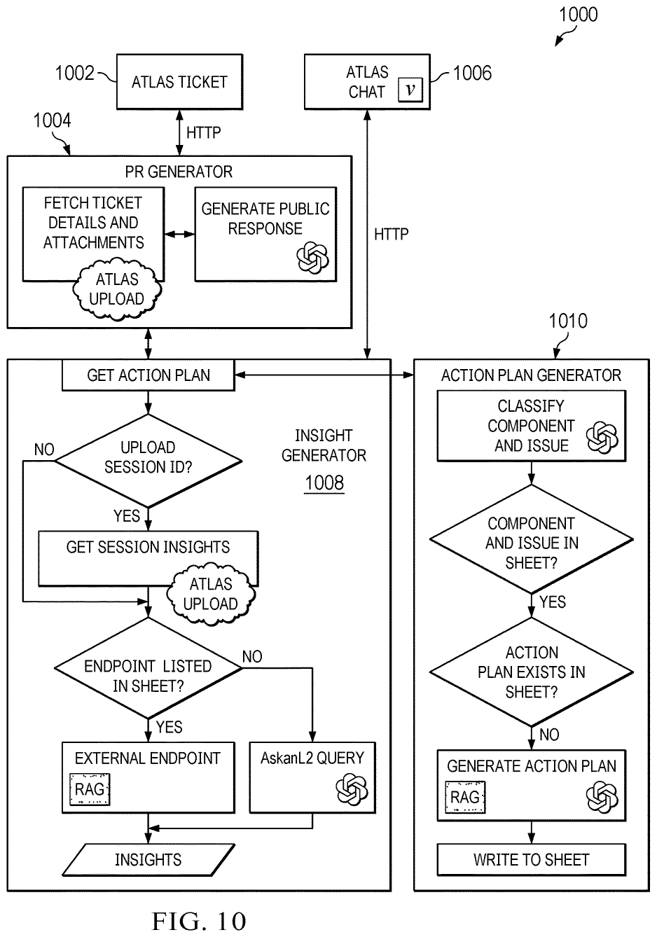

FIG. 10 depicts a detailed flow chart 1000 of a process and interactions between different components in the atlas system 1000, which is an embodiment of the exemplary troubleshooting action plan generation method of FIG. 2. In step 1002, the Atlas ticket, which can also be referred to as the ticket management platform 102, collects input from the customer and creates customer ticket 104. The Atlas ticket also collects the user data 106. In step 1004, the generate PR (Pull Request) endpoint is responsible for creating pull requests for resolving a ticket and personalizing the troubleshooting action plan. In step 1006, the Atlas chat allows real-time communication, enabling customers to interact with the Atlas system through chat functionality. In step 1008, the insight generator is used to get an action plan.

In step 1010, the action plan generator classifies components and issues of the product and services received from the customer. The component and issues are checked in the TAP database 112. If the component and issues are available, fetch the action plan from the TAP database 112 and transfer to the technical support bot 118. If the action plan does not exist, then the action plan is generated using the technical support bot 118 and saved into TAP database 112. The steps 1002, 1004, 1006, 1008, and 1010 communicate with each other through HTTP. In at least one embodiment, the steps 1002, 1004, 1006, 1008, and 1010 can work in different sequences.

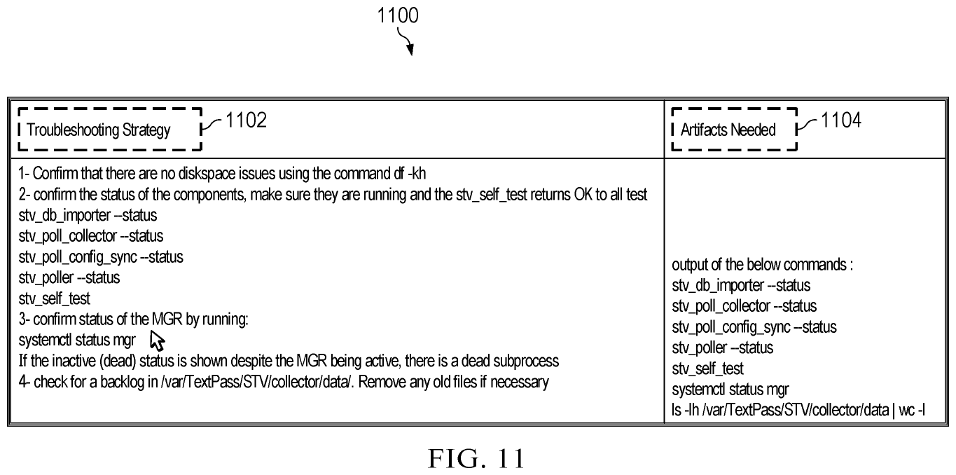

FIG. 11 depicts troubleshooting strategies and artifacts needed for product or service 1100 in the TAP database. The troubleshooting strategies 1102 shows the details of troubleshooting strategies and the artifacts needed 1104 refers to various tools, documents, or pieces of information that are necessary for generating troubleshooting action plan.

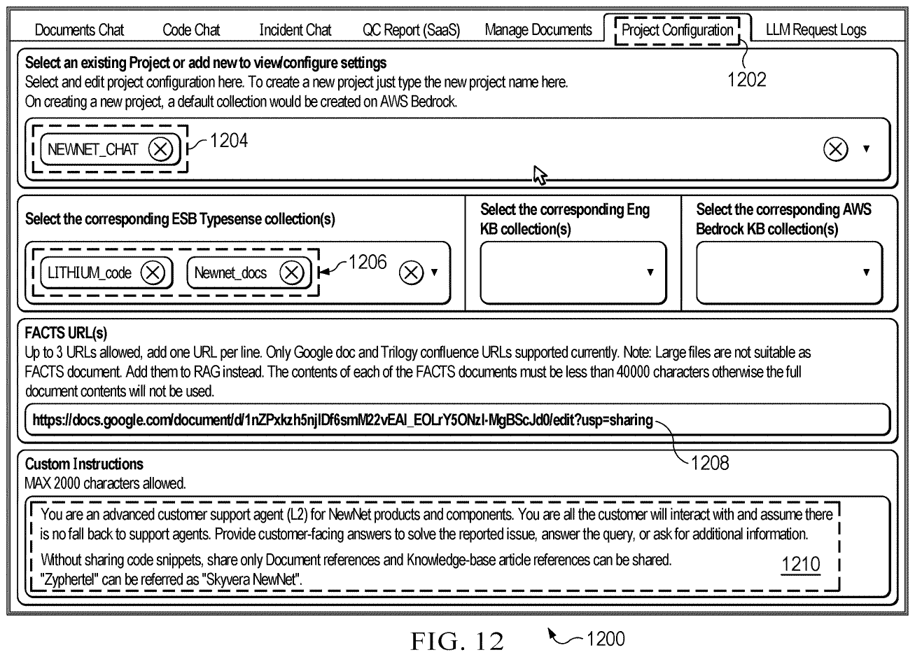

FIG. 12 depicts a user interface 1200 that allows customers to configure a project 1202 in a software system. The user interface 1200 includes options for selecting a project 1204, associated collections for various components 1206, and fields for entering URL links 1208 and custom instructions 1210.

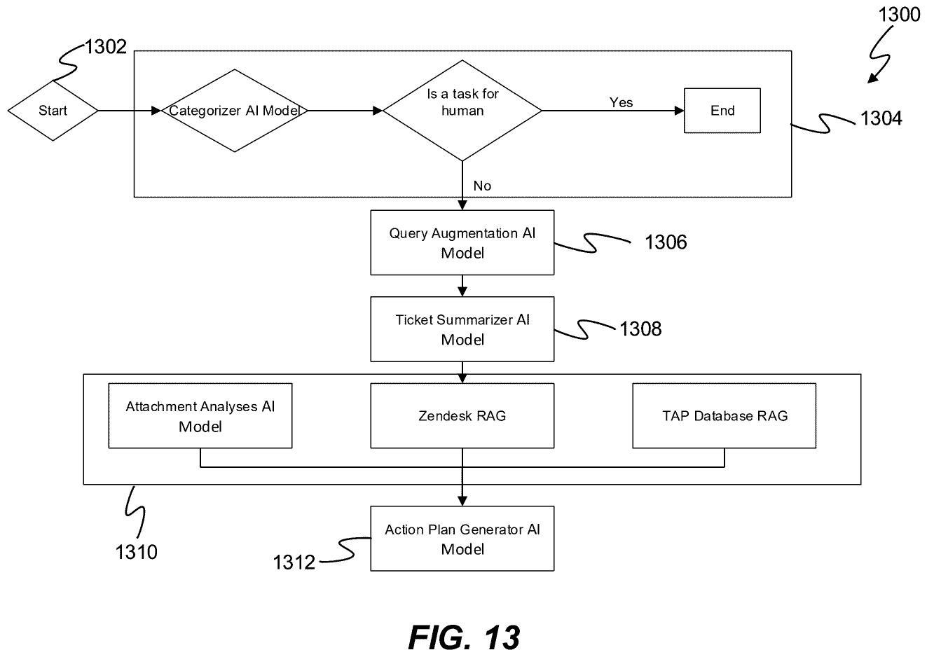

FIG. 13 depicts a flow from categorizing the issues to the generation of a troubleshooting action plan, which is an embodiment of the exemplary troubleshooting action plan generation method of FIG. 2.

In step 1302, a start node where the exemplary troubleshooting action plan generation method is ready to receive inputs for categorizing the issues.

In step 1304, a categorizer AI model, such as an LLM, is designed to analyze and classify text-based data into predefined categories. The categorizer AI model utilizes advanced natural language processing (NLP) techniques. The categorizer AI model can understand the context, intent, and nuances of the input text. The categorizer AI model categorizes the issue and determines whether the issue needs to be handled manually or by the technical support bot 118.

In step 1306, the query augmentation artificial intelligence model 120 improves and enhances the customer ticket 104 to generate more accurate, relevant, and comprehensive responses. By expanding or refining the user data 106, the action plan generator 126 can better understand the customers intent and retrieve more detailed information. The query augmentation artificial intelligence model 120 analyzes the original customer ticket 104, identifies missing elements, ambiguities, or vague terms, and then adds relevant keywords, context, or details to enhance the customer ticket 104. The query augmentation artificial intelligence model 120 processes the customer ticket 104 more effectively, improving the quality of the response. Techniques such as rephrasing, adding synonyms, or incorporating related concepts are often used by the query augmentation artificial intelligence model 120 to make the customer ticket 104 more complete and aligned with the customer's intent.

In step 1308, the ticket summarizer AI model 122 automatically summarizes customer ticket 104. By processing the text within the customer ticket 104, the ticket summarize LLM identifies key information such as the nature of the issue, actions taken, and any outcomes, to generate a concise summary. This allows the action plan generator 126 teams to quickly understand the problem. The ticket summarizer AI model reads the content of customer ticket 104, analyzes the customer ticket 104, and extracts the most critical points.

In step 1310, the attachment analysis LLM 124 automatically reviews, interprets, and extracts key information from attachments such as customer-provided logs, input files, past tickets, or other communications. The attachment analysis LLM 124 processes the content within the attachments, analyzes its structure, and generates insights or summaries based on the material provided. In step 1310, Zendesk RAG and TAP database RAG is also utilized.

In step 1312, the action plan generator 126 generates a troubleshooting action plan for the customer ticket 104, having issues related to one or more components of a product or service. The action plan generator 126 analyzes the details of the customer ticket 104 and generates the necessary steps to resolve the issues in the customer ticket 104 efficiently.

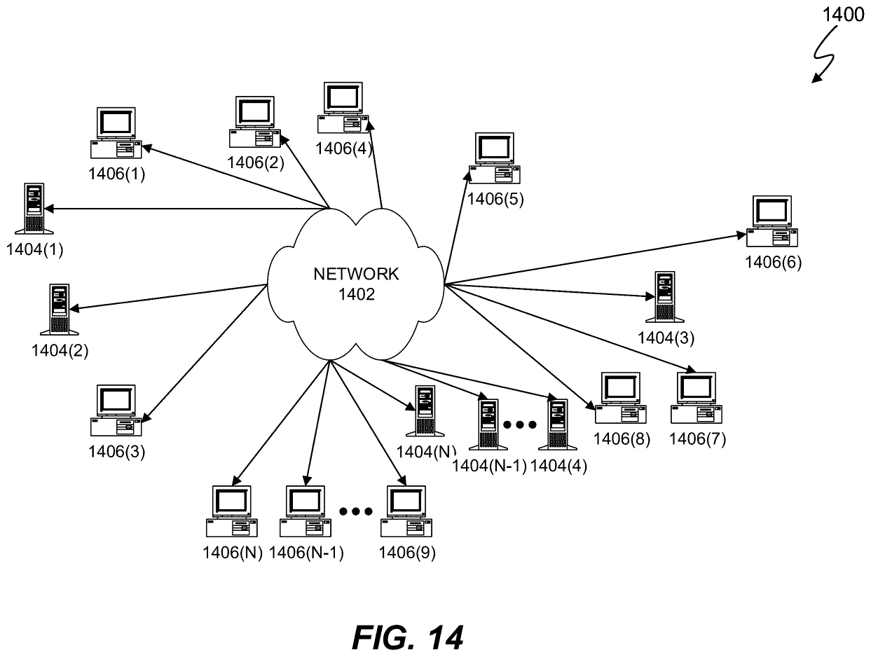

FIG. 14 is a block diagram illustrating a network environment 1400 in which an exemplary troubleshooting action plan generation system 100 and an exemplary troubleshooting action plan generation method 200 may be practiced. Network 1402 (e.g. a private wide area network (WAN) or the Internet) includes a number of networked server computer systems 1404(1)-(N) that are accessible by client computer systems 1406(1)-(N), where N is the number of server computer systems connected to the network. Communication between client computer systems 1406(1)-(N) and server computer systems 1404(1)-(N) typically occurs over a network, such as a public switched telephone network over asynchronous digital subscriber line (ADSL) telephone lines or high-bandwidth trunks, for example communications channels providing T1 or OC3 service. Client computer systems 1406(1)-(N) typically access server computer systems 1404(1)-(N) through a service provider, such as an internet service provider (“ISP”) by executing application specific software, commonly referred to as a browser, on one of client computer systems 1406(1)-(N).

Client computer systems 1406(1)-(N) and/or server computer systems 1404(1)-(N) are specialized computer programmed to improve conventional computer systems to implement and utilize the exemplary troubleshooting action plan generation system 100 and the exemplary troubleshooting action plan generation method 200. The type of computer system that can be specially programmed to implement and utilize the exemplary troubleshooting action plan generation system 100 and the exemplary troubleshooting action plan generation method 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the exemplary troubleshooting action plan generation system 100 and the exemplary troubleshooting action plan generation method 200 can be implemented using code stored in a tangible, non-transient computer readable medium and executed by one or more processors. In at least one embodiment, the exemplary troubleshooting action plan generation system 100 and the exemplary troubleshooting action plan generation method 200 can be implemented completely in hardware using, for example, logic circuits and other circuits including field programmable gate arrays.

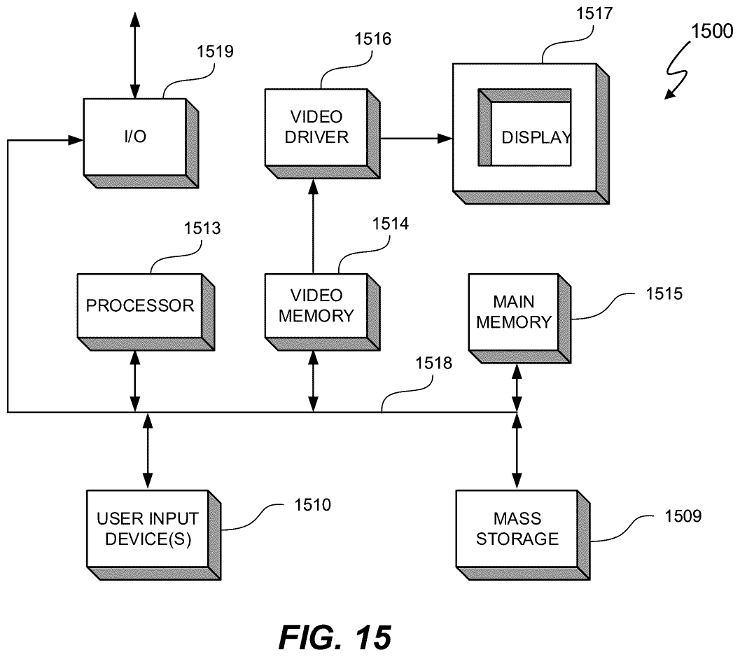

Embodiments of the exemplary troubleshooting action plan generation system 100 and the exemplary troubleshooting action plan generation method 200 can be implemented on a computer system such as a special-purpose, special-programmed computer 1500 illustrated in FIG. 15. Input user device(s) 1510, such as a keyboard and/or mouse, are coupled to a bi-directional system bus 1518. The input user device(s) 1510 are for introducing user input to the computer system and communicating that user input to processor 1513. The computer system of FIG. 15 generally also includes a non-transitory video memory 1514, non-transitory main memory 1515, and non-transitory mass storage 1509, all coupled to bi-directional system bus 1518 along with input user device(s) 1510 and processor 1513. The mass storage 1509 may include both fixed and removable media, such as a hard drive, one or more CDs or DVDs, solid state memory including flash memory, and other available mass storage technology. Bus 1518 may contain, for example, 32 of 64 address lines for addressing video memory 1514 or main memory 1515. The system bus 1518 also includes, for example, an n-bit data bus for transferring DATA between and among the components, such as CPU 1509, main memory 1515, video memory 1514 and mass storage 1509, where “n” is, for example, 32 or 64. Alternatively, multiplex data/address lines may be used instead of separate data and address lines.

I/O device(s) 1519 may provide connections to peripheral devices, such as a printer, and may also provide a direct connection to a remote server computer systems via a telephone link or to the Internet via an ISP. I/O device(s) 1519 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1509, into main memory 1515 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1513, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1515 is comprised of dynamic random access memory (DRAM). Video memory 1514 is a dual-ported video random access memory. One port of the video memory 1514 is coupled to video amplifier 1516. The video amplifier 1516 is used to drive the display 1517. Video amplifier 1516 is well known in the art and may be implemented by any suitable means. This circuitry converts pixel DATA stored in video memory 1514 to a raster signal suitable for use by display 1517. Display 1517 is a type of monitor suitable for displaying graphic images.

The computer system described above is for purposes of example only. The exemplary troubleshooting action plan generation system 100 and the exemplary troubleshooting action plan generation method 200 may be implemented in any type of computer system or programming or processing environment. It is contemplated that the exemplary troubleshooting action plan generation system 100 and the exemplary troubleshooting action plan generation method 200 might be run on a stand-alone computer system, such as the one described above. The exemplary troubleshooting action plan generation system 100 and the exemplary troubleshooting action plan generation method 200 might also be run from a server computer systems system that can be accessed by a plurality of client computer systems interconnected over an intranet network. Finally, the exemplary troubleshooting action plan generation system 100 and the exemplary troubleshooting action plan generation method 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for guiding an Artificial Intelligence (AI) engine to generate troubleshooting action plan comprising:
executing code using one or more processors of a computer system to cause the computer system to perform operations comprising:
receiving a customer ticket, via a ticket management platform, wherein the customer ticket includes one or more issues related to a product or service and user data, which includes customer provided logs, input files, and past tickets;
accessing data from a troubleshooting action plan (TAP) database, including details related to one or more components, issues descriptions, general troubleshooting strategies, and artifacts;
mapping the one or more issues related to the product or service with one or more components in the TAP database and extracting the details connected to one or more components from the TAP database via a mapping module;
generating a prompt, via a prompt generator, for generating the troubleshooting action plan for the customer ticket, wherein necessary data is fetched from the user database and the TAP database for the prompt generation;
providing the generated prompt and other data fetched by the customer support system from the user data and the TAP database to a technical support bot;
generating troubleshooting action plan via an action plan generator present inside the technical support bot.

2. The method of claim 1 wherein the mapping module categorizes the issues based on different products or services and components of the products or services, determining if human intervention is required and ensuring human intervention when necessary.

3. The method of claim 1 further comprises component-specific troubleshooting, wherein the component having the issues is identified and the troubleshooting action plan is made with respect to the component.

4. The method of claim 1 wherein a customer support Zendesk retrieval augmented generation (RAG) and a TAP database RAG are used to enhance the ability to retrieve relevant information.

5. The method of claim 1, wherein a prompt engineer generates a basic structure of the prompt and the prompt generator modifies the prompt.

6. The method of claim 1, wherein the troubleshooting action plan (TAP) database stores the output from the AI engine and utilizes the stored output when required for similar customer tickets.

7. The method of claim 1 wherein the customer support Zendesk platform attempts to retrieve additional context related to the same or similar customer tickets.

8. The method of claim 1 wherein the troubleshooting action plan is passed to a user through a user interface or to one or more automation levels for post-processing.

9. The method of claim 1 wherein the troubleshooting action plan generation method is configured to produce a step-by-step and timely resolution, thereby enabling the user to reduce downtime.

10. The method of claim 1 wherein the AI engine uses fallback mechanisms when unable to generate specific strategies.

11. A system for guiding an Artificial Intelligence (AI) engine to generate troubleshooting action plan comprising:
one or more processors of a computer system; and
a memory, coupled to the one or more processors, that stores code and execution of the code by the one or more processors causes the computer system to perform operations comprising:
receiving a customer ticket, via a ticket management platform, wherein the customer ticket includes one or more issues related to a product or service and user data, which includes customer provided logs, input files, and past tickets;
accessing data from a troubleshooting action plan (TAP) database, including details related to one or more components, issues descriptions, general troubleshooting strategies, and artifacts;
mapping the one or more issues related to the product or service with one or more components in the TAP database and extracting the details connected to one or more components from the TAP database via a mapping module;
generating a prompt, via a prompt generator, for generating the troubleshooting action plan for the customer ticket, wherein necessary data is fetched from the user database and the TAP database for the prompt generation;
providing to an artificial intelligence (AI) engine the generated prompt and other data fetched by the customer support system from the user data and the TAP database to a technical support bot; and
generating troubleshooting action plan via an action plan generator present inside the technical support bot, wherein the technical support bot also includes query augmentation artificial intelligence model, ticket summarizer AI model, and attachment analysis AI model for supporting the generation of troubleshooting action plan.

12. The system of claim 11 wherein the mapping module categorizes the issues based on different products or services and components of the products or services, determining if human intervention is required and ensuring human intervention when necessary.

13. The system of claim 11 wherein execution of the code by the one or more processors causes the computer system to perform further operations comprising:
component-specific troubleshooting, wherein the component having the issues is identified and the troubleshooting action plan is made with respect to the component.

14. The system of claim 11 wherein Zendesk retrieval augmented generation (RAG) and a TAP database RAG are used to enhance the ability to retrieve relevant information.

15. The system of claim 11 wherein a prompt generator generates the basic structure of the prompt, and the prompt generator modifies a basic structure of an engineered prompt to guide and constrain the AI engine.

16. The system of claim 11, wherein the troubleshooting action plan (TAP) database stores the output from the AI engine and utilizes the stored output when required for similar customer tickets.

17. The system of claim 11 wherein Zendesk attempts to retrieve additional context related to the same or similar customer tickets.

18. The system of claim 11 wherein the troubleshooting action plan is passed to a user through a user interface or to one or more automation levels for post-processing.

19. The system of claim 11 wherein the troubleshooting action plan generation system is configured to produce a step-by-step and timely resolution, thereby enabling the user to reduce downtime.

20. The system of claim 11 wherein the AI engine uses fallback mechanisms when unable to generate specific strategies.
